(19) United States
(12) Patent Application Publication
(10) Pub. No.: US 2026/0252883 A1
(43) Pub. Date: Aug. 27, 2026

(54) METHODS AND SYSTEMS FOR TRAINING MODELS AGAINST CONVOLUTIONAL PERTURBATIONS

(71) Applicant: Safe Intelligence Limited, Haringey, London (GB)

(72) Inventors: Benedikt Brückner, London (GB); Alessio Lomuscio, London (GB)

(21) Appl. No.: 19/550,935

(22) Filed: Feb. 26, 2026

Related U.S. Application Data
(60) Provisional application No. 63/764,561, filed on Feb. 27, 2025.

(51) Int. Cl. G06N 3/08; G06N 3/0464; G06V 10/778; G06V 10/82

(52) U.S. Cl. CPC G06N 3/08; G06N 3/0464; G06V 10/778; G06V 10/82

(57) ABSTRACT

The present disclosure is directed to methods and systems that provide for a certified training approach that utilizes an efficient encoding of convolutional perturbations, like motion blur, to train provably robust models. Perturbation kernels are constructed based on selected input, and parameterized versions of the perturbation kernels are derived as one or more matrices. Results of convolved inputs are precomputed with the matrix(ices), and a threshold number of layers are prepended to a user model based on the precomputed results, in turn generating an augmented model. Bounds for the augmented model are determined, and parameters for the augmented model are updated based on the determined bounds. Output can then be returned based on the augmented model. The methods can be performed and the systems operated until the user model is optimized and robustified against perturbations.

### CROSS REFERENCE TO RELATED APPLICATION(S)

The present disclosure claims priority to and the benefit of U.S. Provisional Patent Application No. 63/764,561, entitled “METHODS AND SYSTEMS FOR TRAINING MODELS AGAINST CONVOLUTIONAL PERTURBATIONS,” filed on Feb. 27, 2025, the content of which is incorporated by reference herein in its entirety.

### TECHNICAL FIELD

This disclosure generally describes methods and systems for training models (e.g., images), and more particularly relates to a pipeline for training models, such as neural networks, to improve robustness against convolutional perturbations.

### BACKGROUND

Neural networks trained for image processing tasks can often be brittle and may produce unexpected results under slight changes of their input, including perturbations such as motion blur, which frequently may appear in real-world systems. This can impede deployment of such models in safety-critical domains, including but not limited to self-driving cars and aviation. While additional training data and methods such as Adversarial Training can decrease the risk of unforeseen failures of a model, such techniques lack the ability to certify the safety of a given model. A person skilled in the art will appreciate Adversarial Training is a special type of training paradigm for neural networks, an example of which is provided at https://arxiv.org/abs/1706.06083 (the content at the link of which is incorporated by reference herein in its entirety). The method works such that, during training of a model, an input is taken, and then an effort(s) can be made to modify this input slightly so the network produces an incorrect output for the input (“adversarial example”). This modified input is used to retrain the model. There are multiple Adversarial Training techniques, one of which is Projected Gradient Descent (PGD).

Models trained using standard training approaches can be difficult to verify. This is due, for example, to looseness of convex relaxations, which existing verifiers employ to model nonlinear dependencies. Some training methods aim at training verifiably robust networks, often by adding a loss component based on bounds on the model's outputs to the training loss. At least because models may have unforeseen weaknesses and blind spots, methods for verifying the robustness to input perturbations are needed.

### SUMMARY

The disclosure generally describes technology for a model training framework that can be used to robustify models, such as neural networks, to various perturbations, including but not limited to convolutional perturbations. For example, the disclosed technology can provide for training models that are certifiably robust to motion blur and related convolutional perturbations. By exploiting low dimensionality of perturbation encoding together with an efficient, batched implementation, the disclosed technology can employ tight bounding methods at training time. In doing so, the disclosed technology can significantly reduce overregularization induced by looser bounding, existing systems. This enables the disclosed technology to find a sweet spot between standard accuracy and robustness, thereby producing models with high accuracy and good robustness.

A person skilled in the art, in view of the present disclosures, will appreciate that the present methods and systems, which involve a certified training pipeline as described in greater detail below, are different than the way traditional Adversarial Training operates (e.g. as described above in the Background section). An evaluation of the disclosed technology can also be performed across a variety of perturbations and/or corruption strengths to prove the training pipeline's efficiency. For reasonably-sized motion blur and/or sharpen perturbations, higher certified accuracies can be achieved than pure Adversarial Training. Even for strong perturbations, the disclosed technology can result in models with a certified accuracy of over 70%. For many runs, standard and robust accuracies are well above those of the existing systems and methods for white noise. This demonstrates the practical relevance of robustification to perturbations, such as motion blur, due to the improved trade-off between accuracy and robustness.

The systems and techniques described herein may provide one or more of the following advantages. For example, the disclosed technology provides technical solutions in the form of an efficient and accurate training pipeline to produce models that are robust against convolutional perturbations. Vision models have been found to be susceptible to perturbations, such as, by way of non-limiting example, motion blur induced at runtime by a shaking camera. This impedes deployment at least because phenomena such as slightly blurred vision might lead to failures, for example an object detector missing objects. Existing systems for training models can involve data augmentation and/or generation, which can be expensive and, at least at times, inefficient. The existing systems are also unable to provide formal safety guarantees for the trained models, making it challenging to uncover hidden weaknesses of said models. The disclosed technology, on the other hand, provides technological improvements and solutions to the existing systems with an improved model training pipeline. The disclosed pipeline can utilize an efficient encoding of convolutional perturbations, such as motion blur, to train provably robust models. The disclosed technology can significantly outperform the existing systems based on Adversarial Training, thereby obtaining models with a certified accuracy of over 80% to motion blur of a reasonable intensity.

The disclosed technology provides a streamlined pipeline that accurately trains models against various perturbations in ways that reduce processing time and improve consumption of available resources. The disclosed pipeline can be injected into existing systems and/or run in a separate, remote system/server. The pipeline can be used to seamlessly train any model, such as a neural network, to be robust against any type of perturbations, including but not limited to convolutional perturbations. The existing systems, on the other hand, do not provide a pipeline that can be easily deployed to provide accurate and efficient training of models against the different types of perturbations. Therefore, the disclosed technology provides technical improvements to the existing solutions.

Moreover, the disclosed technology, and more specifically the automated operations of the training pipeline described herein, cannot be reasonably performed in the human mind. The pipeline employs specific operations for which to train different types of models to be robust against different types of convolutional perturbations and other perturbations. Said specific operations are performed iteratively and in real-time to generate reliable and accurate results—those results being a certifiably robust model. The disclosed technology, therefore, provides efficient model training that does not require human intervention and input, thereby making it impossible for this technology to be performed in the human mind. The robustified models of the present disclosure can be iteratively executed during runtime and simultaneously updated to generate reliable and accurate results, functions that cannot be reasonably performed in the human mind in real-time or even near real-time.

Advantages of certified training using the perturbation formalization provided for herein as compared to more naïve methods, such as adversarial training, include that a training time, the techniques and systems disclosed herein consider a dense set of possible input perturbations and train the model to be robust to all of the instantiations of the perturbation(s) under consideration. The resulting models are more robust and more reliable, so the performance is higher. Accordingly, they need to be replaced less often.

The details of one or more implementations are set forth in the accompanying drawings and the description below. Other features and advantages will be apparent from the description and drawings, and from the claims.

### BRIEF DESCRIPTION OF THE DRAWINGS

The disclosure will be more fully understood from the following description taken in conjunction with the accompanying drawings, in which:

FIG. 1 is a conceptual diagram of a system for training a model, such as a neural network, to be robust against perturbations;

FIGS. 2A and 2B is a flowchart of a process for training a model to be robust against perturbations;

FIGS. 3A and 3B illustrate example visualizations of kernel effects;

FIGS. 4A and 4B illustrate example tables of results for evaluating the disclosed training pipeline;

FIG. 5 is a table of an example network used with the disclosed technology;

FIG. 6 is a table of example parameters that can be used for training;

FIG. 7A is a table of average runtimes when using the disclosed training pipeline in an illustrative example;

FIG. 7B is a table of example weight decay values for an example study using the disclosed technology;

FIG. 8 is a table of example ablation study results;

FIG. 9 illustrates graphs representing example ablation study results; and

FIG. 10 is a schematic diagram that shows an example of a computing device and a mobile computing device for use in conjunction with the processes of the present disclosure.

### DESCRIPTION OF ILLUSTRATIVE EMBODIMENTS

Certain embodiments will now be described to provide an overall understanding of the principles of the methods and systems disclosed herein. One or more examples of these embodiments are illustrated in the accompanying drawings. Those skilled in the art will understand that the methods and systems specifically described herein and illustrated in the accompanying drawings are non-limiting exemplary embodiments and that the scope of the present disclosure is defined solely by the claims. The features illustrated or described in connection with one exemplary embodiment may be combined with the features of other embodiments. Such modifications and variations are intended to be included within the scope of the present disclosure. In the present disclosure, like-number components of various embodiments generally have similar features when those components are of a similar nature and/or serve a similar purpose, unless otherwise noted or otherwise understood by a person skilled in the art.

This disclosure generally relates to techniques for training models that are both accurate and certifiably robust against perturbations. The robustness of these models can be significantly increased compared to models trained with existing systems, which is useful for deploying models in a range of real-life situations where motion blur, optic-created blurring, and/or other perturbations can occur. The disclosed technology can evaluate trained models in a dense neighborhood of inputs, providing formal safety guarantees before deployment. For reasonable perturbation strengths, the disclosed technology can improve certified accuracy from 0% to about 82% for motion blur while experiencing approximately a 1% decrease in accuracy. For sharpen perturbations, the disclosed technology can also result in increasing certified accuracies to over 80% across all perturbation strengths.

Existing systems for verifying neural networks aim at proving nonexistence of adversarial examples within the neighborhood of a given input. These systems can rely on Mixed Integer Linear Programming (MILP) and/or Satisfiability Modulo Theories (SMT) solvers, branching, and/or tighter constraints to accelerate verification. Interval Bound Propagation (IBP) propagates concrete bounds through the network. Alternatives such as (Forward) Symbolic Interval Propagation (SIP) or CROWN/back-substitution typically exploit symbolic bounding equations to gain precision. To obtain even tighter relaxations of the nonlinear activation functions in a network, Semidefinite Programming (SDP)-based relaxations and/or linear constraints relaxing multiple neurons simultaneously can be used. The existing systems can also use GPU-enabled parallelism together with specialized Branch-and-Bound (BaB) frameworks to allow for the verification of large networks and complex specifications. Such systems can investigate robustness of neural networks to white noise, often represented by pixel-wise perturbations bounded in the l_{∞} norm. Photometric perturbations, such as changes to the brightness and contrast of an image, geometric perturbations, such as translations or rotations, as well as occlusions of an input, can equally be encoded. More complex perturbations may be modeled using the latent space of generative models.

A related problem to the verification of a network's robustness is that of training networks to be more robust. Adversarial Training can increase empirical robustness while Robust/Verified/Certified Training can aim at improving certifiable robustness and verifiability of a model. This can be done, for example, by adding regularization to Adversarial Training and/or by using sound upper bounds of the worst-case loss during training. A person skilled in the art, in view of the present disclosures, will appreciate Robust/Verified/Certified Training all refer to methods that first compute bounds for neurons in a neural network and then use these bounds to compute a worst-case loss for a specific training objective (e.g., to compute the largest possible value that a loss function used for training can possibly attain while the inputs are perturbed in a given way). This worst-case loss can then be used for training the neural network. An example reference for a survey on the topic is provided at https://arxiv.org/abs/2406.04848 (the content at the link of which is incorporated by reference herein in its entirety).

State-of-the-art (SoA) approaches can combine over- and under-approximations of the true worst-case loss, thereby making use of IBP for bounding. Sometimes, Gaussian Loss Smoothing can be used to enable the use of tighter bounds during training while employing SDP-based bounds during training. In some implementations, certified training on low-dimensional bias field perturbations can be used.

In the following disclosure, bold lower-case letters a can be used to denote vectors and bold upper-case letters A can be used to denote matrices and tensors. Square brackets can be used for indexing vectors, matrices and tensors with, e.g., A[i, j] denoting the element in row i and column j of the matrix A and A[i,:] the i-th row of A. Further, I*K can be written for the convolution of a matrix I with a kernel K. The term vec(A) can be used for the vectorization of a matrix or tensor, e.g. if A∈ [symbol] and a=vec(A) then a∈ [symbol] . The inverse operation can be vec⁻¹, to clarify the shape of the output may be added. For the above example, one can write

$$v e {c}_{m , n}^{- 1} ( a )$$

to restore the original A.

Starting with feed-forward neural networks, a feed-forward neural network (FFNN) ƒ: [symbol] → [symbol] can operate on an input x∈ [symbol] . It is a function that can be defined as the composition of multiple individual functions ƒᵢ: [symbol] → [symbol] , which are usually referred to as layers. A network can be composed of L∈ [symbol] such layers, where each layer can be said to have a number of nᵢ neurons. Each layer's output xᵢ can be computed by applying the layer's operation to the previous layer's output vector, e.g., xᵢ=ƒᵢ(xᵢ₋₁), i∈{1, . . . , L} with x₀=x being the input to the network. The operation represented by each layer of a network generally can be assumed to be composed of two components. The first component can be a linear mapping lᵢ [symbol] → [symbol] , xᵢ₋₁ [symbol] Wᵢxᵢ₋₁+bᵢ, with Wᵢ∈ [symbol] referred to as the weight matrix and bᵢ∈ [symbol] referred to as the bias vector. The expression \hat{x}ᵢ=lᵢ(xᵢ₋₁) can be used to refer to this pre-activation vector. The second component can be the application of a non-linear activation function σᵢ: [symbol] → [symbol] , therefore xᵢ=σᵢ(\hat{x}ᵢ). Many activation functions, such as sigmoid, tanh, and/or Rectified Linear Unit (ReLU) can be used in neural networks. In some illustrative examples, neural networks with ReLU activations can be used. That said, both verification and certified training can be equally feasible for networks incorporating other activation functions.

In the following illustrative examples, the network can perform image classification tasks. Let c denote the number of classes in a given dataset, then a classification network can have n_{L}=c and the predicted class of an input can be j=arg maxₖ x_{L}[k].

Turning to Neural Network Verification and bound computation, Neural Network Verification can aim at certifying the robustness of a trained neural network ƒ to perturbations of its input. For a set of admissible inputs, [symbol] ⊂ [symbol] , the aim can be to prove or disprove that all of the outputs produced by ƒ for inputs in [symbol] lie in a safe output set [symbol] ⊂ [symbol] , formally:

$${∀}_{x} ∈ : \text{?} : f ( x ) ∈ 𝕆 . \qquad ( 1 ) .$$

Perturbations of a given strength ϵ can be bounded in the l_{∞} norm. Let x̅ be an input that belongs to class k′ and that is correctly classified by ƒ. Then [symbol] ={x∈ [symbol] ∥x−x̅∥_{∞}≤ϵ} can be set. The corresponding output set for a classification problem can be [symbol] ={y∈ [symbol] ∥y[k′]>y[k]∀k≠k′}. To determine whether Equation 1 holds, most SoA verifiers make use of bound propagation.

Interval Bound Propagation can be the cheapest and least precise method that can propagate concrete bounds through the network and performs propagation through non-linear ReLU layers by considering the smallest and largest value attainable by the ReLU function. Given concrete lower and upper bounds lᵢ₋₁, uᵢ₋₁ for a layer, the bounds for the following layer can be calculated as:

$${l}_{i} = {W}_{i}^{+} {l}_{i - 1} + {W}_{i}^{-} {u}_{i - 1} + {b}_{i} and {u}_{i} = {W}_{i}^{+} {u}_{i - 1} + {W}_{i}^{-} {l}_{i - 1} + {b}_{i} .$$

A potential drawback can be the significant over approximations introduced at each nonlinear layer, leading to coarse bounds for deeper networks.

Symbolic Bound Propagation methods may alleviate this issue by propagating symbolic bounding equations through the network. This can enable them to keep track of dependencies between different neurons, leading to tighter bounds. The original symbolic propagation method, often named Forward SIP (FSIP) or Standard SIP (SSIP), performs the computations in a forward manner, starting at the input layer of the network and iteratively proceeding to its output layer. Tighter bounds can also be obtained by starting bounding at the network layer of interest and performing the propagation in a reversed manner, successively back-substituting the variables in the bounding equations with symbolic representations of the previous layer's operation until reaching the input layer. This method can be referred to as back-substitution, CROWN, DeepPoly, or Reversed Symbolic Interval Propagation (RSIP). Each one of these methods can introduce approximation errors.

Additional precision can be gained by combining either of the above bounding methods with a branching strategy, such as splitting the input intervals and/or splitting the input regions for hidden nodes to obtain multiple subproblems with tighter approximations.

Now considering Adversarial and Certified Training, a neural network ƒ_{θ}: [symbol] → [symbol] with parameters θ can be normally trained on a dataset [symbol] containing pairs of inputs and labels (x, y) by solving the following optimization problem:

$${min}_{θ} {𝔼}_{( x , y ) ∼ 𝔻} ℒ ( {f}_{θ} ( x ) , y ) . \qquad ( 2 )$$

Networks trained by using this standard training loss can be easily attackable using various adversarial attack paradigms at least because the above formulation may not induce stability of the model around a given input. Let [symbol] (x, ϵ) denote a set of admissible perturbations of a clean input x. In some implementations, [symbol] (x, ϵ)={\tilde{x}∈ [symbol] ∥\tilde{x}−x∥_{∞}≤ϵ} can be defined and the following can be solved:

$${min}_{θ} {E}_{( x , y ) ∼ 𝔻} {max}_{\tilde{x} ∈ 𝕀 ( x , ∈ )} ℒ ( {f}_{θ} ( x ) , y ) . \qquad ( 3 )$$

However, the maximization of [symbol] (ƒ_{θ} (x), y) can be a nonconvex optimization problem. Instead of solving it exactly, Adversarial Training (AT) can be introduced to find a local maxima for the inner problem by using, e.g., Projected Gradient Descent (PGD). Computing the loss on them can yield a lower bound for the true optimum of the inner maximization problem, which can be used to update the model. This method can make it more difficult to find adversarial examples using attacks (e.g., increases the empirical robustness), while often leading to decreased standard accuracies. Further, the model can usually be difficult to verify, and adversarial examples can still be found, for example, using stronger attacks.

Certified Training can follow a different approach by first computing lower and upper bounds for each neuron in the output layer using algorithms, such as IBP, SSIP, and/or RSIP. Instead of using the outputs ƒ_{θ}(x) of the network inside the loss function, the bounds can be used to compute an upper bound of the true optimum of the inner maximization problem. This certified training loss can induce a strong regularization effect during training, achieving increased stability of the trained model and facilitating verification at the expense of a decreased standard accuracy.

Early methods may use IBP bounds and/or combinations of IBP and tighter CROWN bounds for training, but may require long training schedules and/or warm-up phases, during which the perturbation size can be ramped up to achieve satisfying performance. The length of the training schedules can sometimes be reduced by adding batch normalization (BN) layers to the network, developing a custom weight initialization called IBP Initialization, and/or adding a warmup loss during the warmup phase to stabilize bound tightness and activation states. Some systems of Certified Training for white noise can use IBP bounds as a sound over approximation, but can combine them with an Adversarial Training component. For low-dimensional perturbations, such as brightness perturbations, the change to a pixel of an input image can be identical across all pixels. It can be generally expected that tighter bounds will be obtained from bounding algorithms for such a perturbation compared to a white noise perturbation where each pixel can vary independently. However, for the example of the low-dimensional bias field perturbation, Certified Training using IBP can be ineffective due, at least in part, to the loss of dependency information in IBP. This can be mitigated by instead using SSIP and/or RSIP for bounding. These methods can preserve the dependency information, producing significantly tighter bounds for low-dimensional perturbations. While providing tighter bounds than SSIP, one drawback of RSIP can be that a separate bound computation pass typically should be initiated for every activation layer. RSIP-SSIP may be used as a cheaper, yet still effective alternative, which first uses SSIP to calculate the bounds for all layers in the network and then uses one final RSIP pass to obtain tight bounds on the robust loss.

With respect to convolutional perturbations, the discrete convolution operation can be frequently used in signal as well as image processing. In image processing, one can imagine the computation of the output of a convolution of an image I with a kernel K as being executed by sliding K across the image. At each location, the elementwise product of the entries of K with those entries of I that are covered by K can be computed. These results can be summed up to yield an output value for the corresponding pixel at that location. The semantic meaning of the result can change depending on the kernel used for convolving an image. It is possible to apply various blurring effects, such as box blur, Gaussian blur, and/or motion blur, as well as sharpening effects using appropriate kernels. Multiple of these phenomena can likely appear in computer vision (CV) systems in the real world. Testing the performance of such a system on perturbed images or attacking using noise models, such as adversarial blurring, can give an indication of its performance under perturbations. Still, neither of these techniques can provide guarantees that a model is actually robust.

Some methods can provide for verifying the robustness of a model to perturbations applied using an arbitrary kernel of a predefined size as long as it is normalized. However, this approach may provide loose bounds and/or may not scale to larger networks. Parameterized kernels can be used instead to model convolutional perturbations in a way that enables scaling to larger networks while still considering robustness for dense input regions containing an infinite number of instantiations of the perturbation. A linear parameterization can therefore be used with a parameter z∈[0,1] to transition from an identity kernel to a perturbation kernel. In the simple example of box blurring with a kernel size of s=3, the parameterization can include:

$${P}_{z = 0} = ( \begin{matrix}0 & 0 & 0 \\ 0 & 1 & 0 \\ 0 & 0 & 0\end{matrix} ) , {P}_{z = 1} = ( \begin{matrix}\frac{1}{9} & \frac{1}{9} & \frac{1}{9} \\ \frac{1}{9} & \frac{1}{9} & \frac{1}{9} \\ \frac{1}{9} & \frac{1}{9} & \frac{1}{9}\end{matrix} ) . \qquad ( 4 )$$

This equation can be used to derive a linear parameterization P_{z}=Cz+D where C, D, P∈ [symbol] and z∈ [symbol] . Due, at least in part, to the fact that the identity kernel is not well-defined for even kernel sizes, perturbation kernels with uneven size s may only be considered in this illustrative example. For z=0, the identity kernel can be obtained, which may not change an image I when it is convolved with it. As z increases, kernels can be obtained that may achieve increasingly stronger perturbation effects until eventually reaching full perturbation strength for z=1. For an image I and an arbitrary parameterized kernel K=Az+B, it can be shown that:

$$I * K = \underbrace{( I * A ) z}_{{R}_{A}} + \underbrace{( I * B )}_{{R}_{B}} . \qquad ( 5 )$$

The result of the two convolutions R_{A}, R_{B} can therefore be computed separately. The result of the perturbation of I with K for an arbitrary z∈[0,1] can be obtained by simply computing I_{perturbed}=R_{A}·z+R_{B}. No new convolution needs to be run for this, only the multiplication of R_{A} with the scalar z may be required before adding the result to R_{B}. This approach can be used to encode convolutional perturbations for arbitrary kernels K into a verification framework that may then be used to certify robustness for any perturbation strength within a dense interval [0, ϵ].

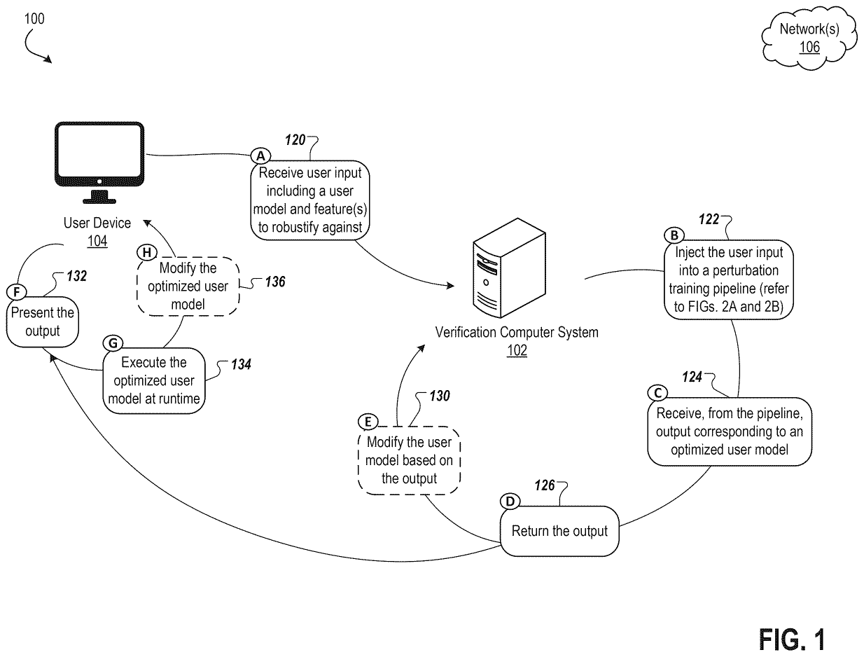

Referring to the figures, FIG. 1 is a conceptual diagram of a system 100 for training a model, such as a neural network, to be robust against perturbations. The system 100 can include a learning computer system 102 in network communication (e.g., wired, wireless) with a user device 104 via network(s) 106. The learning computer system 102 can be a computing system, server, and/or cloud-based system that can be configured to execute or otherwise perform a training pipeline as described herein. In some implementations, the pipeline described herein can be performed remotely and/or at the user device 104 having appropriate programming language (e.g., Python) and hardware components (e.g., CPU cores, memory, and/or GPU, among others) to run the pipeline, and in least some instances the pipeline can be performed on any system(s) capable of executing machine learning models, including edge-based devices. The user device 104 can be a computing device, laptop, tablet, mobile phone, computer, and/or smartphone.

In the system 100, the learning computer system 102 can receive, from the user device 104, user input, including at least a user model and one or more features to robustify the model against (block A, 120).

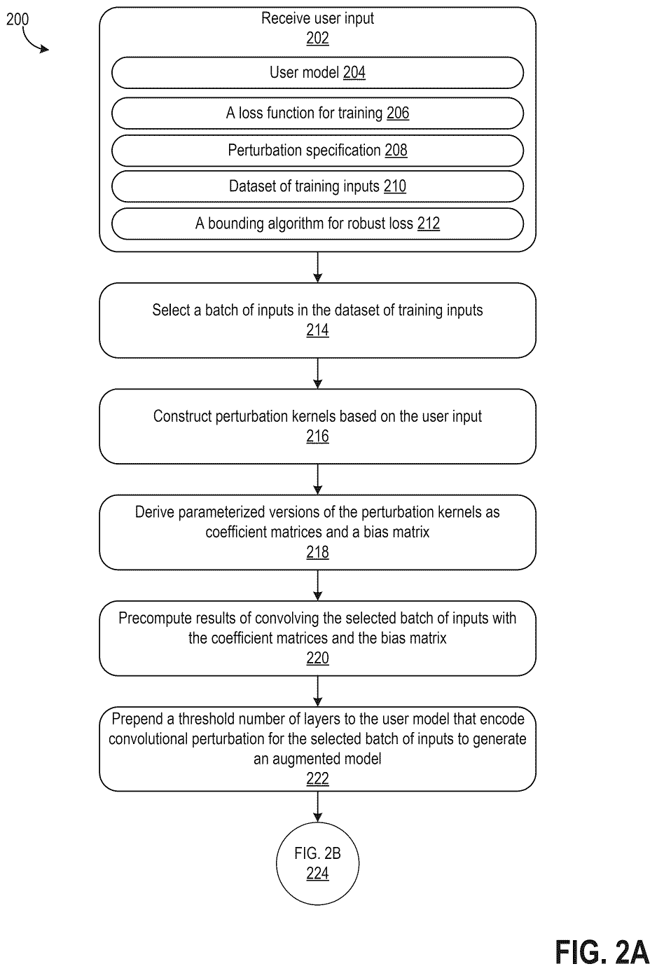

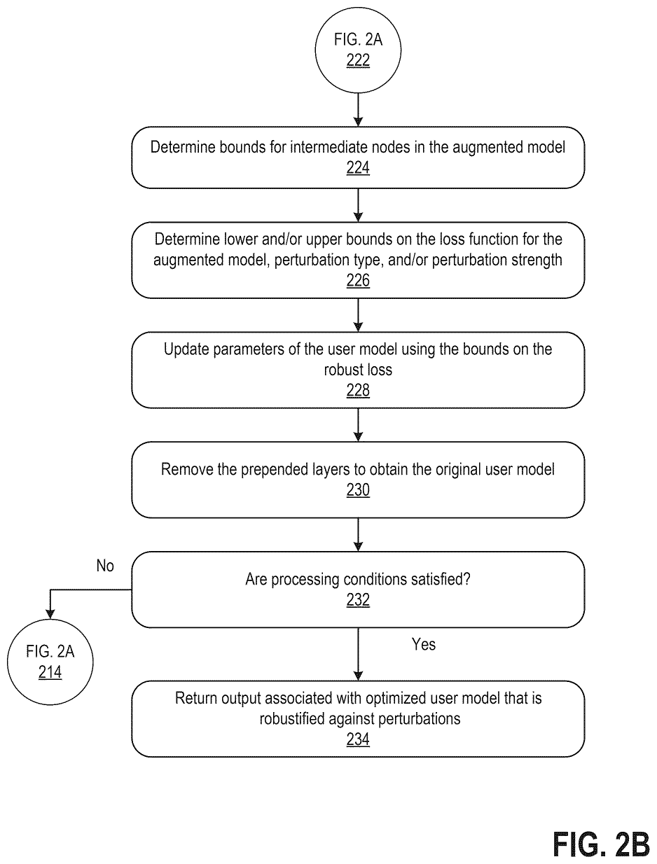

The learning computer system 102 can inject the user input into a perturbation training pipeline in block B, 122. Refer to FIGS. 2A and 2B for further discussion about the training pipeline.

The computer system 102 can receive, from the pipeline, output corresponding to an optimized user model (block C, 124).

The system 102 can also return the output to the user device 104 in block D (126). The user device 104 can be configured to present the output (block F, 132). The user device 104 can also execute the optimized user model at runtime in block G (134). Optionally, the user device 104 can modify the optimized user model based on the returned output (block H, 136). Block H (136) can be performed before, during, and/or after the blocks F (132) and/or G (134).

Optionally, in some implementations, the learning computer system 102 can modify the user model based on the output (block E, 130).

FIGS. 2A and 2B is a flowchart of an example of a process 200 for training a model to be robust against perturbations.

The process 200 can be performed by components of the learning computer system 102 described herein. The process 200 can also be performed by one or more other software modules, applications, and/or engines that are programmed to perform the disclosed techniques. Such software modules, applications, and/or engines can be implemented by one or more computing systems, devices, computers, networks, cloud-based systems, and/or cloud-based services. For illustrative purposes, the process 200 is described from the perspective of a computer system. Further, one or more of the actions disclosed in the flowchart of FIG. 2 can be modified, skipped over, removed, and/or replaced without departing from the spirit of the present disclosure. The inclusion of all the disclosed actions in FIG. 2 does not require that all such actions must be performed. It is contemplated that other methods supported by the present disclosure may be directed to any subset of the actions provided for in the figure, and that other actions can also be included with any portion of the actions provided for in the illustrated flowchart.

Referring to the process 200 in FIGS. 2A and 2B, the computer system can receive user input in block 202. The user input can include a user-specified robust training problem. The user input can include, but is not limited to, one or more of a user model (block 204), a loss function for training (block 206), a perturbation specification (block 208), a dataset of training inputs (block 210), and/or a bounding algorithm for robust loss (block 212). The user model can be a neural network to be trained. The dataset in block 210 can be used for training and/or validation. The perturbation specification in block 208 can include, but is not limited to, perturbation kernels of interest (e.g., box blur kernels, sharpen kernels, motion blur kernels), parameters for the perturbation kernels, such as size of perturbation kernels and/or perturbation-specific parameters, such as angle of motion blur, and/or maximum perturbation strength (e.g., ‘epsilon’) to consider for robustification, and/or bounding algorithms to be used for robust loss (e.g., SSIP and/or RSIP).

In block 214, the computer system can select a batch of inputs in the dataset of training inputs. The computer system can construct perturbation kernels based, at least in part, on the user input in block 216. The computer system can use perturbation kernel(s) that may be specified by the user. At least sometimes the computer system can use one or more predetermined perturbation kernels.

The computer system can derive parameterized versions of the perturbation kernels as coefficient matrices and a bias matrix (block 218). The computer system can derive parameterized versions of the kernels such that the parameterized versions may be equal to an identity kernel for z=0 and a given perturbation kernel for z=1. This can result in one or more coefficient matrices Aᵢ and one bias matrix B.

In block 220, the computer system can precompute results of convolving the selected batch of inputs with the coefficient matrices and the bias matrix. In other words, the computer system can use batched convolution operation to precompute the results of convolving the batch of training data with the coefficient kernels Aᵢ and the bias kernel B.

The computer system can also prepend a threshold number of layers to the user model that encode one or more convolutional perturbations for the selected batch of inputs, thereby generating an augmented model (block 222). The threshold number of layers can be defined by the user, such as in the perturbation specification. In some implementations, the threshold number of layers can be predetermined by the computer system. The number of layers can vary at least based on perturbations to be encoded and/or one or more parameters that are designated by the relevant user. As an illustrative example, two layers can be used-one for encoding the actual perturbation (e.g., which outputs a vector or matrix) and one layer for reshaping the outputted vector/matrix into a format of an image (e.g., number of pixels along x axis, number of pixels along y axis, number of channels in the image). If the user specifies that additional operations should be performed (e.g., clipping the output of the perturbation to a valid interval), then more layers may be included. For example, the computer system can prepend the layers using customized batched matrix multiplication layer, as well as a reshape layer to form the augmented model (e.g., an augmented network).

Next, the computer system can determine bounds for intermediate nodes in the augmented model (block 224). The computer system can calculate the bounds using SSIP, at least in some implementations.

The computer system can also determine upper and/or lower bounds on the loss function for the augmented model, perturbation type, and/or perturbation strength (which may be defined by the perturbation specification) (block 226). The computer system can calculate the lower and/or upper bounds using SSIP and/or RSIP, at least in some implementations.

In block 228, the computer system can update parameters of the user model using the bounds on the robust loss. At least sometimes, the computer system can combine robust loss with other loss types, including but not limited to standard loss.

The computer system can remove the prepended layers to obtain the original user model in block 230.

Accordingly, the computer system can determine whether one or more processing conditions are satisfied (block 232). The processing conditions can include but are not limited to a threshold or maximum number of epochs and/or a threshold or required robust performance metric.

If the processing conditions are satisfied, the computer system can return output associated with the optimized user model that can be robustified against perturbations (block 234). The optimized user model can therefore be robust against the user-specified types of perturbations in the perturbation specification.

If the processing conditions are not satisfied, the computer system can return to block 214, in which the computer system selects a batch of inputs in the dataset, then iterate through the process 200 until the processing conditions are met.

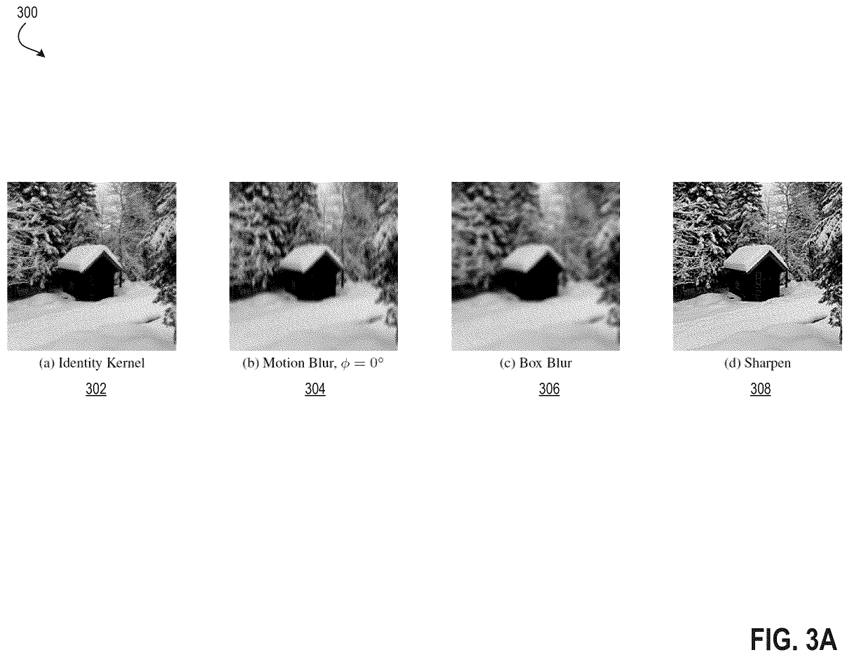

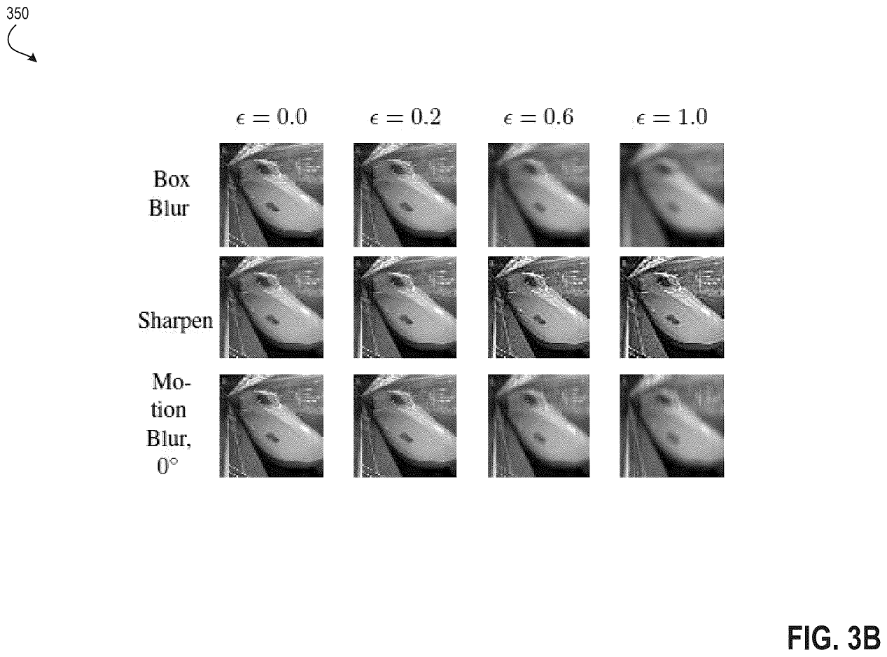

FIGS. 3A and 3B illustrate example visualizations of kernel effects. FIG. 3A shows example visualizations of kernel effects using kernels 302, 304, 306, and 308. Such kernels can include the identity kernel 302, the motion blur kernel 304, the box blur kernel 306, and/or the sharpen kernel 308. The effect each of these kernels 302, 304, 306, and 308 has on an image is also shown in FIG. 3A. Note that for inputs with multiple color channels, the convolution can be performed independently for each channel.

As described herein, a user associated with a network and/or model can designate what types of perturbations to robustify their model against. They can identify, for example, which of the kernels 302, 304, 306, and/or 308 ought to be selected and applied in the training pipeline described herein.

FIG. 3B shows an example visualization 350 of different perturbations and their strengths ϵ on a 64×64 image using a kernel size of s=5. The visualization 350, which is constructed using an example image of a bullet train from the TinyImageNet (a standard dataset in the field of computer vision), shows that parameterized kernels as described herein are effective at smoothly modeling different degrees of perturbations. This visualization 350 further shows perturbing an input image using perturbation kernels for box blur, sharpen, and motion blur perturbations (with a blurring angle of) 0° for perturbation strengths of 0.0 (no perturbation), 0.2, 0.6, and 1.0. By incorporating perturbations based on parameterized kernels into the described robust training framework, the disclosed technology effectively robustifies neural networks against such perturbations.

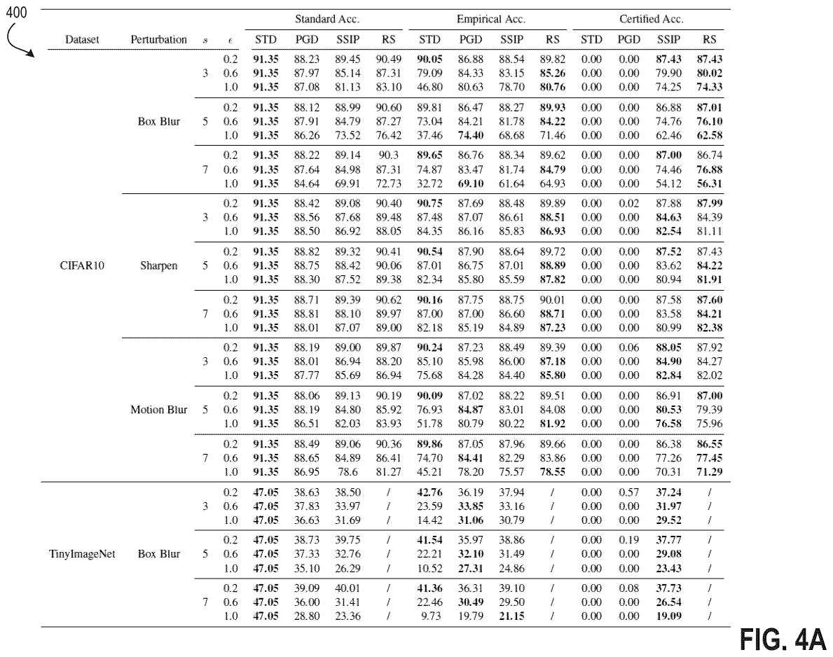

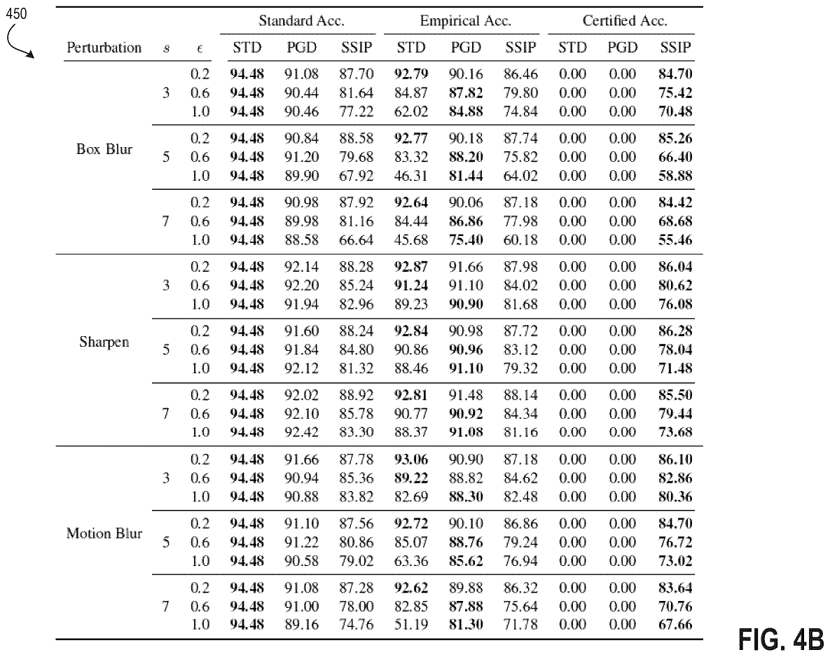

FIGS. 4A and 4B illustrate example tables 400 and 450, respectively, of results for evaluating the disclosed training pipeline. Referring generally to FIGS. 4A and 4B, training verifiably robust models with high standard accuracies can be a challenging problem due, at least in part, to the fact that both standard and Adversarial Training approaches produce models that can be vulnerable to corruptions of the inputs. Certified Training, on the other hand, can often be slow, may suffer from loose bounds and risks overregularizing the model. Besides this, the popular IBP-based Certified Training can be highly ineffective for robustifying models against low-dimensional perturbations. The disclosed training pipeline, on the other hand, can provide a Certified Training scheme for convolutional perturbations that makes use of SSIP and RSIP bounds to effectively keep track of the low-dimensional structure of perturbations at hand. By exploiting this low dimensionality instead of relying on high-dimensional encodings producing looser bounds, the disclosed technology can void overregularization of the models and preserve a high standard accuracy on the tasks at hand. Together with an efficient, batched perturbation encoding, the disclosed technology can obtain a highly effective framework for training models that are verifiably robust to convolutional perturbations.

The table 400 shows results of training an example CNN7 architecture (a standard neural network architecture in certified training works) on two different datasets, an example CIFAR10 dataset and an example TinyImageNet dataset. The model can be trained with standard and adversarial training along with the training methods described herein for robustifying the model against convolutional perturbations, such as sharpening, camera shake, etc.

The table 450 shows results on a different model, a ResNet18 architecture, which is another standard model in computer vision but is significantly larger than the CNN7 architecture. This model is only evaluated on the CIFAR10 dataset due to long training times but, as in the table 400, the disclosed technology can robustify the model against convolutional perturbations.

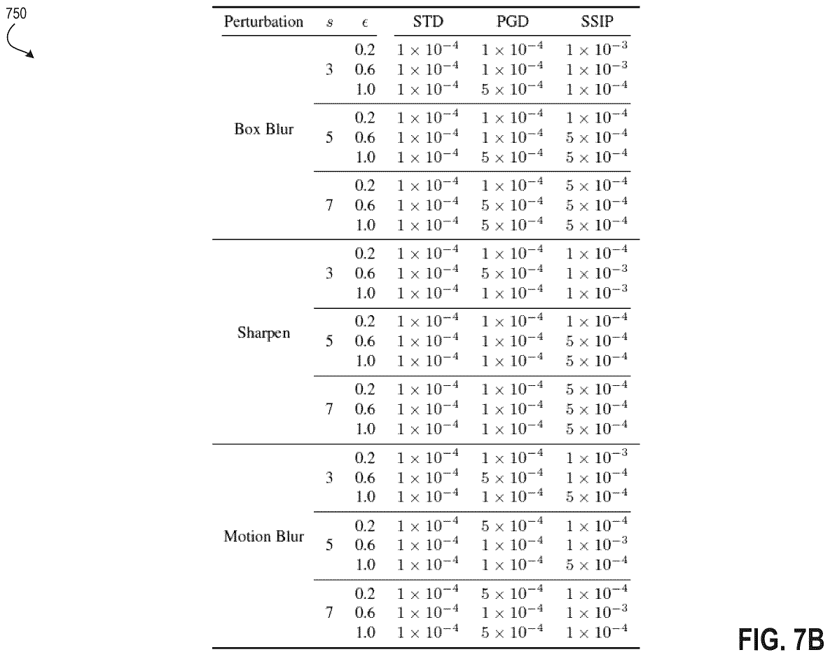

Moreover, to evaluate robust training on a larger neural network architecture, standard, adversarial, and SSIP-based robust training runs can be performed on a model such as a ResNet18 model using a known dataset (e.g., CIFAR10 dataset as a merely illustrative example). Due to size of the model, RSIP-based robust training can lead to substantial memory requirements and therefore may be infeasible. The results of such an evaluation are shown in the table 450 of FIG. 4B. These models may be found to achieve higher standard accuracies on datasets compared to other models described herein due to its increased model capacity. Without robust training, the robust accuracy from single bound propagation passes can be zero (0) for both standard and adversarial training across different settings. For models with a depth similar to that of the tested model described herein, robust training may be necessary to achieve a nonzero certifiable robustness using single bound propagation passes. Comparing the performance of the tested model with that of other models described herein (e.g., CNN7), due to a large depth of the tested model, robust training can introduce substantial regularization at training time to preserve verifiability of the neural network. While this can lead to increased robustness compared to models trained with standard training, it may come at a high cost in terms of standard accuracy. For the robustly trained models, lower standard accuracies may exist for the tested model compared to the other models described herein due to heavy regularization. Nevertheless, the disclosed robust training techniques extent to larger network architectures and can robustify those to a significant extent. For the tested model, for example, correctly choosing a weight decay (refer to FIG. 7B) can also play a role and lead to differing accuracies. To account for this, the weight decay can be tuned for each training run by conducting a run for values of 10⁻³, 5×10⁻⁴, 10⁻⁴ and selecting a run with the highest standard accuracy. The optimal weight decay can be chosen for each setting, as shown in FIG. 7B. Sometimes, batch normalization layers may also be added to the tested model to improve its performance.

The disclosed training pipeline makes use of layers being prepended to a model to encode the desired perturbations. Certified Training poses additional challenges to the prepended encodings at least because they need to support batched processing of the inputs. The disclosed technology can assume that for a training step, a batch of images I∈ [symbol] is given, where o_{b} is the batch size, o_{c} the number of channels of the image, oₕ the image height, and o_{w} the image width. Parameterized perturbation kernels can then be used to simulate perturbations such as motion blur or sharpen. These can be written as K=Az+B with z∈ [symbol] as well as K, A, B∈ [symbol] where s is the size of the perturbation kernel. To obtain the linear coefficients for encoding the perturbation in a parameterized way, Equation 5 described above can be used. Using a batched convolution operation, the coefficient and bias tensor R_{A}, R_{B} for the entire batch can be computed by convolving each input in the batch with A, B. Reflect padding can be used to ensure that R_{A}, R_{B}∈ [symbol] . Example 1 demonstrates computations for a toy input.

Example 1 provides for the sample calculations. In the example, it can be assumed that an image J∈ [symbol] and a motion blur kernel M∈ [symbol] simulating blurring along the angle φ=0° can be given as:

$$M = ( \begin{matrix}0 & \frac{1}{3} & 0 \\ 0 & \frac{1}{3} & 0 \\ 0 & \frac{1}{3} & 0\end{matrix} ) , J = ( \begin{matrix}0 & 0 & 0 & 0 \\ 0 & 3 & 6 & 0 \\ 0 & 3 & 6 & 0 \\ 0 & 0 & 0 & 0\end{matrix} ) . \qquad ( 6 )$$

For the sake of simplicity, pixel values outside [0,1] can be used for this example. Using the information that the parameterized kernel G_{z} must be equal to the identity kernel for z=0 and equal to M for z=1, the parameterisation can be computed as:

$${M}_{z} = \underbrace{( \begin{matrix}0 & \frac{1}{3} & 0 \\ 0 & - \frac{2}{3} & 0 \\ 0 & \frac{1}{3} & 0\end{matrix} )}_{A} z + \underbrace{( \begin{matrix}0 & 0 & 0 \\ 0 & 1 & 0 \\ 0 & 0 & 0\end{matrix} )}_{B} . \qquad ( 7 )$$

The result of the convolution of the batched image with the coefficient and bias kernel is:

$${R}_{A} = ( \begin{matrix}0 & 2 & 4 & 0 \\ 0 & - 1 & - 2 & 0 \\ 0 & - 1 & - 2 & 0 \\ 0 & 2 & 4 & 0\end{matrix} ) \qquad ( 8 )$$

$${R}_{B} = ( \begin{matrix}0 & 0 & 0 & 0 \\ 0 & 3 & 6 & 0 \\ 0 & 3 & 6 & 0 \\ 0 & 0 & 0 & 0\end{matrix} ) . \qquad ( 9 )$$

As an example, for z=0, it may be that:

$${J}_{perturbed} = {R}_{A} \cdot 0 + {R}_{B} = {R}_{B} = J . \qquad ( 10 )$$

To obtain a slightly blurred image, set z=0.5 and calculate the result as:

$${J}_{p e r t u r b e d} = {R}_{A} \cdot 0.5 + {R}_{B} \qquad ( 11 )$$

$$= ( \begin{matrix}0 & 1 & 2 & 0 \\ 0 & 2.5 & 5 & 0 \\ 0 & 2.5 & 5 & 0 \\ 0 & 1 & 2 & 0\end{matrix} ) . \qquad ( 12 )$$

The result can be an image that has been blurred along the φ=0° axis. Let d=o_{c}·oₕ·o_{w} be the number of pixels in each image in a batch. After running the pre-computation for a batch, the obtained tensors can be transformed to:

$${R}_{A}^{′} = {vec}_{{o}_{b} , d , 1}^{- 1} ( v e c ( {R}_{A} ) ) \qquad ( 13 )$$

$${R}_{B}^{′} = {vec}_{{o}_{b} , d}^{- 1} ( v e c ( {R}_{B} ) ) . \qquad ( 14 )$$

This can be equivalent to flattening each image in a batch to become a vector with a trailing dimension of size one. A layer that encodes the linear operation based on R′_{A}, R′_{B} can be prepended to the network. This layer can take the input to the model \tilde{z}∈ [symbol] , and can apply the linear mapping to each entry in \tilde{z}. Here, the i-th entry \tilde{z}[i] controls the degree to which the i-th image in the batch is perturbed. Using Einstein notation, the batched operation encoded in the layer can be written as

$${I}_{p e r t u r b e d}^{′} [ i , j ] = {\sum }_{k} ( {R}_{A}^{′} [ i , j , k ] \tilde{z} [ i , k ] ) + {R}_{B}^{′} [ i , j ] . \qquad ( 15 )$$

To ultimately obtain the batch of perturbed images,

$${I}_{p e r t u r b e d} = ve {c}_{{o}_{b} , {o}_{c} , {o}_{h} , {o}_{w}}^{- 1} ( {I}_{p e r t u r b e d}^{′} )$$

can be computed. This tensor can then serve as the input for the actual neural network to be trained. A sample calculation for this step of the training is given as Example 2, below.

Example 2 can be used to clarify the computation executed by the batched operation explained above. In the example, it can be assumed that two result tensors R_{A}, R_{B}∈ [symbol] can be given as:

$${R}_{A} [ 1 , 1 , : , : ] = ( \begin{matrix}0 & 3 \\ 2 & 1\end{matrix} ) , {R}_{A} [ 2 , 1 , : , : ] = ( \begin{matrix}1 & 0 \\ 3 & 2\end{matrix} ) \qquad ( 17 )$$

$${R}_{B} [ 1 , 1 , : , : ] = ( \begin{matrix}1 & 1 \\ 1 & 1\end{matrix} ) , {R}_{B} [ 2 , 1 , : , : ] = ( \begin{matrix}2 & 2 \\ 2 & 2\end{matrix} ) . \qquad ( 18 )$$

In this instance, small tensors that differ from R′_{A}, R′_{B} computed in Example 1 are used due, at least in part, to space constraints. However, the following computations can equally be run for larger matrices, such as the ones from the preceding example. In line with the Equation 13 and 14, the following can be calculated:

$${{R}_{A} [ : , : , 1 ]}^{′} = ( \begin{matrix}0 & 3 & 2 & 1 \\ 1 & 0 & 3 & 2\end{matrix} ) , \qquad ( 19 )$$

$${{R}_{B} [ : , : , 1 ]}^{′} = ( \begin{matrix}1 & 1 & 1 & 1 \\ 2 & 2 & 2 & 2\end{matrix} ) . \qquad ( 20 )$$

Choosing \tilde{z}=(0.5 1)^{T} as the perturbation vector, the batched matrix multiplication (see Equation 15) returns:

$$\begin{matrix}{I}_{p e r t u r b e d}^{′} & = & ( \begin{matrix}0 & 1.5 & 1 & 0.5 \\ 1 & 0 & 3 & 2\end{matrix} ) + ( \begin{matrix}1 & 1 & 1 & 1 \\ 2 & 2 & 2 & 2\end{matrix} ) & ( 21 ) \\ & = & ( \begin{matrix}1 & 2.5 & 2 & 1.5 \\ 3 & 2 & 5 & 4\end{matrix} ) . & ( 22 )\end{matrix}$$

Using Equation 16, the final output of the operation in the correct shape is I_{perturbed}, where:

$${I}_{p e r t u r b e d} [ 1 , 1 , : , : ] = ( \begin{matrix}1 & 2.5 \\ 2 & 1.5\end{matrix} ) \qquad ( 23 )$$

$${I}_{p e r t u r b e d} [ 2 , 1 , : , : ] = ( \begin{matrix}3 & 2 \\ 5 & 4\end{matrix} ) . \qquad ( 24 )$$

The convolution of the input can be computed in a parallelized manner as a preprocessing step and can be run once for every batch. Other operations, including partial flattening, batched multiplication, and/or reconstruction of correctly shaped perturbed images, can be linear, thus also differentiable. When these layers are prepended to a network, they can support forward passes, bound propagation, and/or backpropagation of gradients through them. This can enable standard, adversarial, and/or certified training of networks on the perturbations encoded by the layers.

As described above, the current SoA certified training methods can be based on loose IBP bounds that overregularize networks when used in the loss function, leading to decreased standard accuracies. The SoA methods, therefore, can introduce an underapproximation component into their loss formulation to prevent this from happening. By using the tighter bounds from the SSIP and/or the RSIP-SSIP method, the disclosed technology can circumvent these issues without relying on similar methods. In doing so, the disclosed framework retains good standard accuracies while achieving much increased verified accuracies. Besides SSIP and RSIP-SSIP losses, the disclosed technology can also make use of, for example, Projected Gradient Descent (PGD) for computing adversarial examples, which can then be used for training. Denoting the standard cross-entropy loss as [symbol] _{CE} and the robustification loss as [symbol] _{method}, where method ∈{PGD, SSIP, RSIP−SSIP}, the loss function can become:

$${ℒ}_{training} = \frac{{ℒ}_{C E} + {ℒ}_{m e t h o d}}{2} . \qquad ( 25 )$$

Still referring to FIG. 4, the table 400 can provide an experimental evaluation, where s is the kernel size for the perturbation and e the perturbation strength for which both training and verification can be run. PGD denotes Adversarial Training, and SSIP and RS denote Certified Training based on the SSIP and RSIP-SSIP bounding, respectively. Standard Acc. is the accuracy of the network on the test dataset, Empirical Acc. denotes the empirical robust accuracy, the percentage of samples that are still classified correctly under a PGD adversarial attack. Certified Acc. is the certified robust accuracy computed using SSIP for the intermediate bounds and an RSIP pass for the final layer bounds.

The bound propagation implementation of a verifier can be built upon to evaluate the disclosed technology. An existing toolkit can be expanded to enable it to handle convolutional perturbations. It can also be augmented to add the required training functionality as well as a PGD attack implementation. PYTORCH can be used as well as custom code for vectorized computations and the efficient training of models. In an illustrative example, CNN7 architecture and CIFAR10 and TinyImageNet datasets can be used for in the illustrative evaluations. CNN7 can be a convolutional neural network with five (5) convolutional and two (2) fully-connected layers, all layers except for the last one being followed by a ReLU activation layer.

For illustrative training runs, the CNN7 can be used with a Batch Normalization (BN) layer placed between every convolutional/fully-connected layer and its activation layer (except for the last layer). This can be due, for example, to a preliminary ablation study indicating that adding BN layers improves performance. A BN is a standard layer inserted into neural networks that re-centers and/or re-scales the outputs of the preceding layer before feeding them into a next layer, and can help make training faster and/or more stable. The number of warm-up and training epochs can be tuned to be used herein. A setting with 80 warm-up epochs during which the perturbation radius e is linearly increased up to its maximum, followed by 80 epochs of training with the full perturbation magnitude, can be used. For larger perturbation sizes, a longer schedule with 80 warm-up epochs and 260 total epochs can be tested separately. A learning rate of 10⁻⁵ can also be used.

Differences between learning rate schedules can be found to be small with the earlier cosine annealing schedule tending to exhibit slightly increased standard accuracies at the expense of slightly decreased robust accuracies due to its earlier learning rate decay. That scheduler can therefore be used in the illustrative evaluations to preserve standard performance. The results of this evaluation are shown in the table 400. The runs can be repeated for ϵ∈{0.2, 0.6, 1.0} and perturbation kernel sizes s∈{3, 5, 7}. For each of these settings, motion blur perturbations with a blurring angle of 0° can be considered, as well as box blur and/or sharpen perturbations. Training setups combining the PGD, SSIP, and/or RSIP-SSIP loss with a standard cross-entropy loss may also be considered. Each of the trained networks can be evaluated on the entire test set to compute the standard accuracy, the empirical robust accuracy using PGD, and/or the certified robust accuracy using, for example, RSIP-SSIP.

On CIFAR10, both Standard (STD) and Adversarial (PGD) Training yield networks for which only few samples can be verified to be robust using an RSIP-SSIP pass. When rounding the accuracy to two decimal places, a certified accuracy of 0 can be obtained for all networks trained using PGD. This is to be expected since both methods do not enforce verifiability. For both methods, the empirical robustness can be high when perturbations are small. For small kernels and perturbation sizes, it almost reaches its upper bound, the standard accuracy. For larger perturbations, only PGD models may preserve high empirical robustness while that of STD models may be dropped. In the case of these larger perturbations, there can be a notable gap between Empirical Acc. and Standard Acc. for adversarially-trained models. This indicates that as the perturbation space grows, it can become more difficult to produce robust models using adversarial training.

When comparing the RSIP results to the SSIP results, it becomes obvious that the high certified accuracies of the SSIP models come at a cost: their standard accuracies may be significantly lower than those of the RSIP-SSIP models, with the RSIP-SSIP model outperforming the SSIP model's standard accuracy by up to about 2.8% for box blur perturbations at s=7, =1.0. This may be in line with the observation that for very large perturbations, such as motion blur; for ϵ=1.0 and s=7, the RSIP-SSIP model achieves a higher certified accuracy again. This can be due, at least in part, to the decreased standard accuracy for the SSIP model caused by the strong regularization.

For sharpen perturbations, the standard accuracy of the RSIP-trained model can be higher than that of the PGD-trained model. For sharpen perturbations, even if the perturbation magnitude is large, the regularization introduced by the robust loss can be beneficial for the model. For other perturbations, this is not usually the case. Some models that are not robustly trained can already be comparably robust to sharpen perturbations. Hence, the regularization effect induced by the robust loss for sharpen perturbations can be smaller and more fine-grained, benefitting overall performance. Comparing the standard accuracies of Certified Training runs for different perturbation types, it can be observed that robustification to box blur perturbations can lead to a large drop in standard performance while motion blur can lead to a smaller decrease. After all, box blur degrades image quality the most while motion blurring only induces blurring along one axis.

Generally, the disclosed RSIP-SSIP-based approach can be highly effective for training models with a high standard and certified accuracy. For motion blur perturbations and reasonable perturbation sizes such as those induced for s=3, ϵ∈{0.2, 0.6, 1.0}, the disclosed technology increases the certified accuracy from the 0% achieved by PGD to up to 87.92% while reducing standard accuracy by at most 1%. Across all training setups, certified accuracies can be increased to over 70%, except for two strong box blur perturbations that heavily corrupt the image. For reasonable perturbation strengths, this can be achieved at the cost of only slightly decreased accuracies. For models robust to strong image corruptions, there may be decreased standard accuracies. This can be expected according to the trade-off between accuracy and robustness. Using CNN7 on CIFAR10, the state-of-the-art method for Certified Training on white noise can achieve a standard accuracy of just 80.61% for a relatively small ϵ=2255, with a certified accuracy of approximately 61.65%. This can be well below the accuracies for many of the disclosed scenarios, indicating that although robustification against white noise is a more difficult problem, the disclosed technology can also be effective at navigating the trade-off between accuracy and robustness.

As indicated above, the disclosed technology can also be evaluated, in an illustrative example, on TinyImageNet, a standard benchmark. A slightly modified version of CNN7 can be used with a larger fully-connected layer and otherwise similar structure. Due to long training times, analysis can be restricted to box blur perturbations in this case. That said, the disclosed technology can be used for robustifying networks against the other perturbations in a similar manner.

On TinyImageNet, RSIP-based training can be infeasible due, at least in part, to substantial memory requirements associated with RSIP passes through networks with large layers. Therefore, the evaluation was restricted in this illustrative example to PGD- and SSIP-based training. RSIP-SSIP may only be used for calculating certified accuracies on a test dataset. There can be similar tendencies observed as for CIFAR10. Specifically, while PGD-based training generally yields slightly higher standard accuracies (except for small perturbations), it is unable to train networks in a way that allows for them to be verified using the disclosed technology. Meanwhile, SSIP-based training yields robustified networks, which suffer from relatively small drops in standard accuracy for moderate perturbation sizes while achieving significantly higher robust accuracies, demonstrating the effectiveness of the disclosed technology. For large perturbation sizes, robustification against them is possible, for box blur perturbations with a kernel size of s=7 and =1.0, a certified robustness of approximately 19.09% can be obtained. However, networks robustified against such strong perturbations show a larger decrease in standard performance due, at least in part, to the strong regularization effect required at training time to allow for the verification of resulting models.

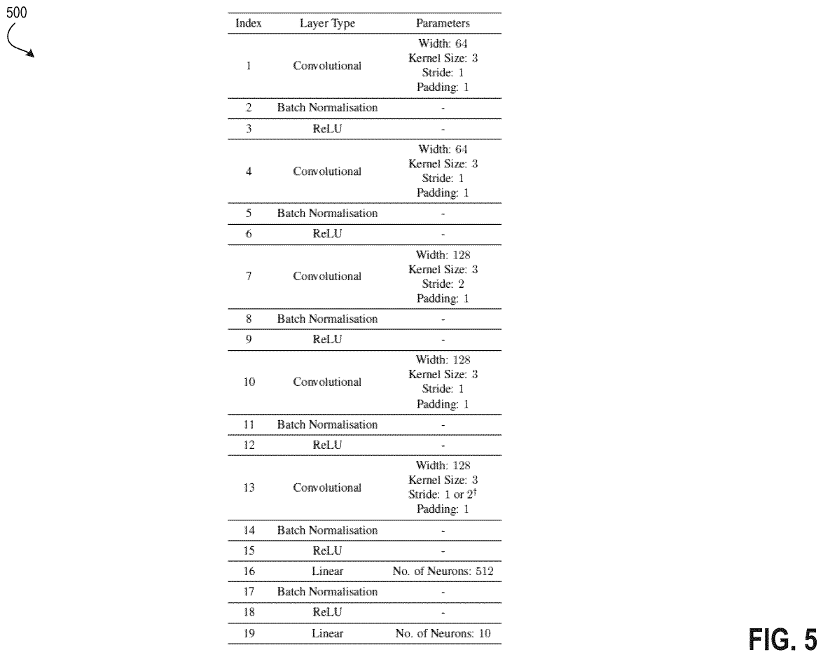

FIG. 5 is a table 500 of an example network used with the disclosed technology, such as CNN7 network. A stride of 1 can be used for the architecture employed on CIFAR10 while a stride of 2 can be used for TinyImageNet. The CNN7 architecture with BN layers can include a convolutional neural network with ReLU activations and seven (7) layers, which has been found to work particularly well with certified training methods while also being able to achieve competitive performance on datasets, such as CIFAR10 and/or TinyImageNet. BN layers can be inserted between the convolutional and activation layers to stabilize training.

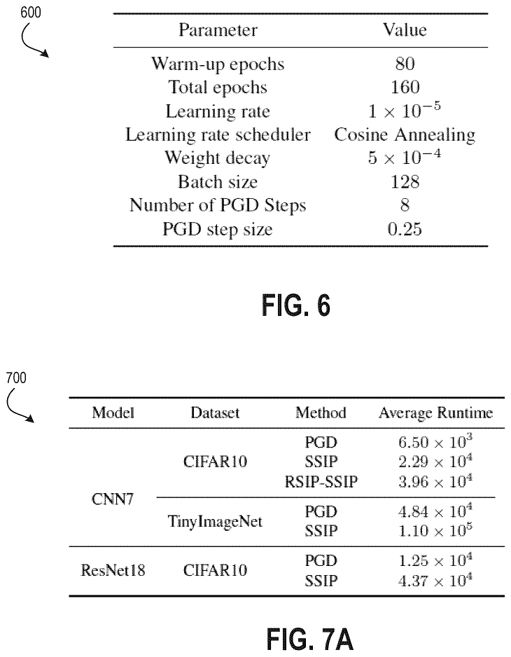

FIG. 6 is a table 600 of example parameters that can be used for training. Table 600 describes at least some key training parameters that have been found to work particularly well for training certifiably robust models with the methods and systems provided for herein.

FIG. 7A is a table 700 of average runtimes when using the disclosed training pipeline in an illustrative example. More specifically, the table 700 provides average runtimes for training on CIFAR10 using example CNN7 and ResNet18 architectures, as well as for a TinyImageNet dataset using the CNN7 architecture. PGD denotes Adversarial Training, SSIP and RSIP-SSIP denote Certified Training based on the respective bounding method. The table 700 also shows average time required for the training runs described herein. As shown, Certified Training with either SSIP or RSIP-SSIP can require additional time when compared to pure Adversarial Training. This is due, at least in part, to cost of the bound computation, which can be incurred for every training batch. However, depending on the scenario at hand, this additional cost can be justified due, at least in part, to superior robustness that certifiably-trained networks exhibit compared to the adversarial trained ones.

Referring to FIGS. 5, 6, and 7A, the CIFAR10 dataset can be used, which contains color images of size 32×32. Images belong to one of ten different classes, such as automobile, airplane, or bird, which are mutually exclusive. Training runs can be conducted on the training dataset, which contains 50,000 images. An evaluation on the test dataset can be run with its 10,000 test images. The mean and standard deviation of each channel on the training dataset can be calculated. Those values can be used to normalize both the training and test set images. To improve performance, random horizontal flipping and random cropping can be used.

The architecture of the employed CNN7 network is shown in the table 400 of FIG. 4. Additional details on the parameters used for training runs are provided in the table 500 of FIG. 5. As indicated, TinyImageNet, a down-sampled and smaller version of ImageNet, can be used in the described evaluation. This dataset can contain 64×64 RGB images from 200 classes with the training set containing 100,000 samples, while the test set contains a further 10,000 images. Normalization and random horizontal flips and random cropping can also be used here. The networks trained on TinyImageNet can further be evaluated on the validation set.

FIG. 7B is a table 750 of example weight decay values used for example runtime uses of the disclosed technology. Weight decay is a technique that can be employed, for example, to prevent overfitting of neural networks to training data and/or to improve generalization of the trained network to new, unseen data. When the weight decay values are too small, for instance, the network can overfit to the training data and may perform poorly on new data. In some implementation, values that are too large may lead to decreased network performance. On the ResNet18 models, which are large, the weight decay value can be tuned for each perturbation type and size. The table 750 shows an optimal weight decay value in the disclosed hyperparameter tuning for each of the perturbation type, perturbation kernel size, and perturbation strength combinations that were evaluated.

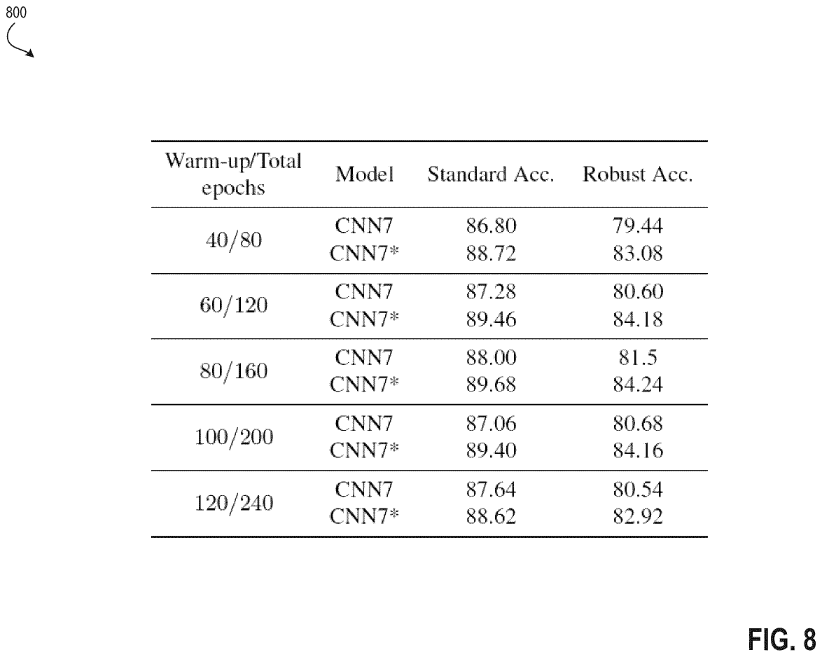

FIG. 8 is a table 800 of example ablation study results. The Ablation Study can be on using CNN7 with versus without batch normalization layers. Networks can be trained using SSIP robust training on box blur perturbations with s=3, ϵ=0.2.

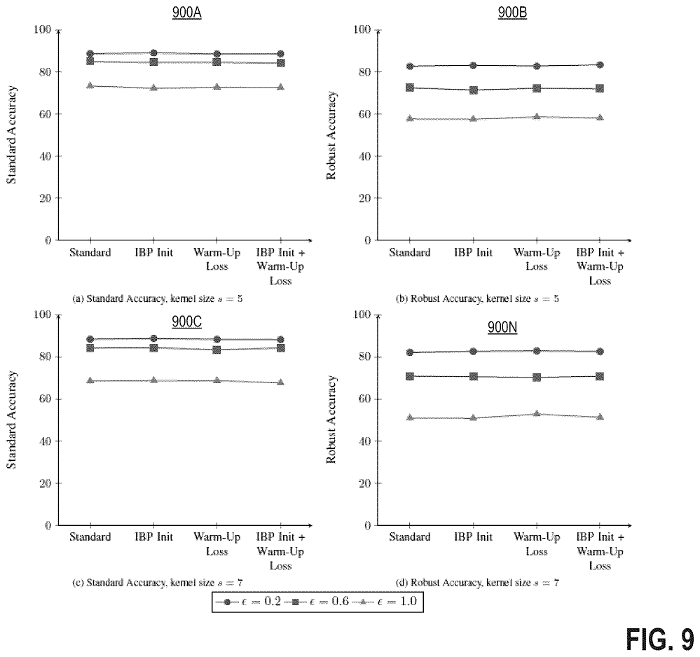

FIG. 9 illustrates graphs 900A, 900B, 900C, and 900N, representing example ablation study results. The Ablation Study can be on using IBP initialization and warm-up loss for Certified Training on convolutional perturbations.

Referring to FIGS. 8 and 9, to check whether fully adding Batch Normalization layers to the CNN7 architecture as suggested for IBP-based Certified Training is beneficial for training neural networks robust to convolutional perturbations, a small initial ablation study can be conducted. Box blur perturbations with a kernel size of s=3 and a strength of ϵ=0.2 can be considered as the noise model for this evaluation. Training runs can be conducted for multiple lengths of training schedules with the CNN7 network as shown in the table 400 of FIG. 4, but also to test CNN7 with all batch normalization layers removed and refer to it as CNN7*. The network can be trained using SSIP robust training and the standard can also be evaluated, as well as the robust accuracy computed by the SSIP bounds. The results are shown in the table 700 of FIG. 7A. The 80/160 schedule outperforms all other schedules, although the differences in performance may be small compared to some of them. The benefit of longer training schedules can also be investigated again for stronger perturbations with ϵ=1.0. However, for this experiment, the 80/160 performed best.

Comparing the performance of CNN7 and CNN7*, CNN7 achieves strictly higher standard and robust accuracies than CNN7*. The differences in performance for the two models can be significant in terms of standard accuracy where an improvement in performance of at least 1% of CNN7 compared to CNN7* can be seen. In terms of robust accuracy, the advantage of CNN7 over CNN7* can be more pronounced with CNN7 reaching robust accuracies up to 3.5% higher than those for the model without batch normalization. Batch normalization layers can not only be useful for Certified Training using IBP bounds, but also beneficial, for instance, where tighter symbolic bounds can be used to construct a training loss.

Besides evaluating the use of batch normalization layers for the described Certified Training scenario, it can also be checked whether the IBP initialization and warm-up loss improve performance for the networks that are trained as described herein. To do so, both of them can be reimplemented to compare the standard and robust accuracy for networks without their proposed changes, with just IBP initialization, with only the warm-up loss, and with both IBP initialization and warm-up loss added. The networks can be trained using the SSIP loss with the test set robust accuracy computed using Symbolic Interval Propagation (SIP) bounds. SIP is a method for using symbolic equations to compute lower and upper bounds for possible output values of neurons in a neural network. The training runs can be repeated for different kernel sizes s∈{5, 7} and perturbation strengths ϵ∈{0.2, 0.6, 1.0} while considering box blur perturbations. The results obtained from these runs are visualized in the graphs 900A, 900B, 900C, and 900N of FIG. 9. Irrespective of the perturbation strength and kernel size, using the IBP initialization to initialize the network weights or the warm-up loss during the warm-up phase of the training process may not have a significant impact on accuracy of the trained networks. This can be true for both the standard and the robust accuracy. Accordingly, IBP initialization or warm-up losses may not be used for the illustrative training runs described herein.

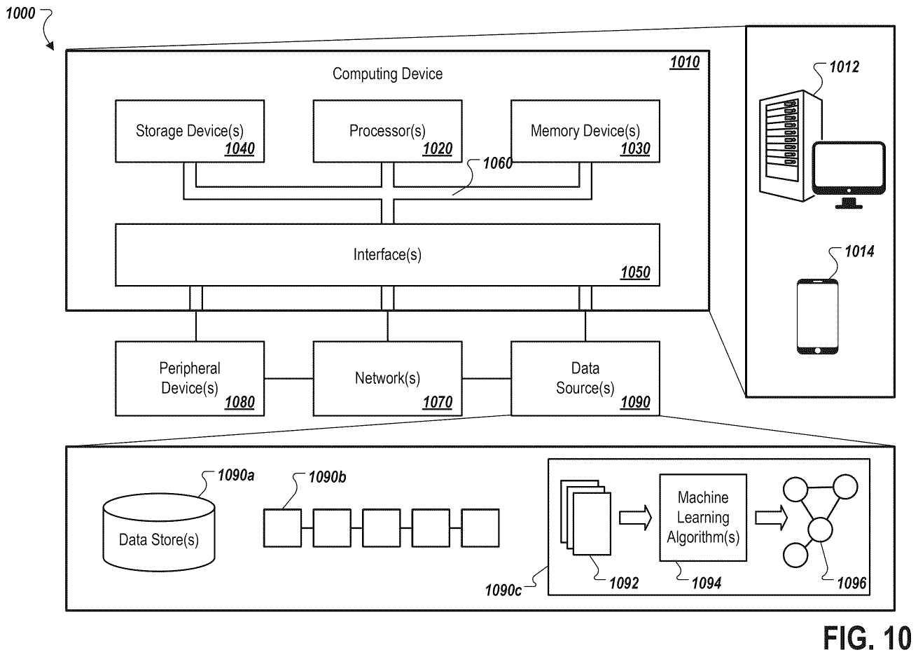

FIG. 10 is a schematic diagram that shows an example of a computing system 1000 that can be used to implement the techniques described herein. The computing system 1000 includes one or more computing devices (e.g., computing device 1010), which can be in wired and/or wireless communication with various peripheral device(s) 1080, data source(s) 1090, and/or other computing devices (e.g., over network(s) 1070). The computing device 1010 can represent various forms of stationary computers 1012 (e.g., workstations, kiosks, servers, mainframes, edge computing devices, quantum computers, etc.) and mobile computers 1014 (e.g., laptops, tablets, mobile phones, personal digital assistants, wearable devices, etc.). In some implementations, the computing device 1010 can be included in (and/or in communication with) various other sorts of devices, such as data collection devices (e.g., devices that are configured to collect data from a physical environment, such as microphones, cameras, scanners, sensors, etc.), robotic devices (e.g., devices that are configured to physically interact with objects in a physical environment, such as manufacturing devices, maintenance devices, object handling devices, etc.), vehicles (e.g., devices that are configured to move throughout a physical environment, such as automated guided vehicles, manually operated vehicles, etc.), or other such devices. Each of the devices (e.g., stationary computers, mobile computers, and/or other devices) can include components of the computing device 1010, and an entire system can be made up of multiple devices communicating with each other. For example, the computing device 1010 can be part of a computing system that includes a network of computing devices, such as a cloud-based computing system, a computing system in an internal network, or a computing system in another sort of shared network. Processors of the computing device (1010) and other computing devices of a computing system can be optimized for different types of operations, secure computing tasks, etc. The components shown herein, and their functions, are meant to be examples, and are not meant to limit implementations of the technology described and/or claimed in this document.

The computing device 1010 includes processor(s) 1020, memory device(s) 1030, storage device(s) 1040, and interface(s) 1050. Each of the processor(s) 1020, the memory device(s) 1030, the storage device(s) 1040, and the interface(s) 1050 are interconnected using a system bus 1060. The processor(s) 1020 are capable of processing instructions for execution within the computing device 1010, and can include one or more single-threaded and/or multi-threaded processors. The processor(s) 1020 are capable of processing instructions stored in the memory device(s) 1030 and/or on the storage device(s) 1040. The memory device(s) 1030 can store data within the computing device 1010, and can include one or more computer-readable media, volatile memory units, and/or non-volatile memory units. The storage device(s) 1040 can provide mass storage for the computing device 1010, can include various computer-readable media (e.g., a floppy disk device, a hard disk device, a tape device, an optical disk device, a flash memory or other similar solid state memory device, or an array of devices, including devices in a storage area network or other configurations), and can provide date security/encryption capabilities.

The interface(s) 1050 can include various communications interfaces (e.g., USB, Near-Field Communication (NFC), Bluetooth, WiFi, Ethernet, wireless Ethernet, etc.) that can be coupled to the network(s) 1070, peripheral device(s) 1080, and/or data source(s) 1090 (e.g., through a communications port, a network adapter, etc.). Communication can be provided under various modes or protocols for wired and/or wireless communication. Such communication can occur, for example, through a transceiver using a radio-frequency. As another example, communication can occur using light (e.g., laser, infrared, etc.) to transmit data. As another example, short-range communication can occur, such as using Bluetooth, WiFi, or other such transceiver. In addition, a GPS (Global Positioning System) receiver module can provide location-related wireless data, which can be used as appropriate by device applications. The interface(s) 1050 can include a control interface that receives commands from an input device (e.g., operated by a user) and converts the commands for submission to the processors 1020. The interface(s) 1050 can include a display interface that includes circuitry for driving a display to present visual information to a user. The interface(s) 1050 can include an audio codec which can receive sound signals (e.g., spoken information from a user) and convert it to usable digital data. The audio codec can likewise generate audible sound, such as through an audio speaker. Such sound can include real-time voice communications, recorded sound (e.g., voice messages, music files, etc.), and/or sound generated by device applications.

The network(s) 1070 can include one or more wired and/or wireless communications networks, including various public and/or private networks. Examples of communication networks include a LAN (local area network), a WAN (wide area network), and/or the Internet. The communication networks can include a group of nodes (e.g., computing devices) that are configured to exchange data (e.g., analog messages, digital messages, etc.), through telecommunications links. The telecommunications links can use various techniques (e.g., circuit switching, message switching, packet switching, etc.) to send the data and other signals from an originating node to a destination node. In some implementations, the computing device 1010 can communicate with the peripheral device(s) 1080, the data source(s) 1090, and/or other computing devices over the network(s) 1070. In some implementations, the computing device 1010 can directly communicate with the peripheral device(s) 1080, the data source(s), and/or other computing devices.

The peripheral device(s) 1080 can provide input/output operations for the computing device 1010. Input devices (e.g., keyboards, pointing devices, touchscreens, microphones, cameras, scanners, sensors, etc.) can provide input to the computing device 1010 (e.g., user input and/or other input from a physical environment). Output devices (e.g., display units such as display screens or projection devices for displaying graphical user interfaces (GUIs)), audio speakers for generating sound, tactile feedback devices, printers, motors, hardware control devices, etc.) can provide output from the computing device 1010 (e.g., user-directed output and/or other output that results in actions being performed in a physical environment). Other kinds of devices can be used to provide for interactions between users and devices. For example, input from a user can be received in any form, including visual, auditory, or tactile input, and feedback provided to the user can be any form of sensory feedback (e.g., visual feedback, auditory feedback, or tactile feedback).

The data source(s) 1090 can provide data for use by the computing device 1010, and/or can maintain data that has been generated by the computing device 1010 and/or other devices (e.g., data collected from sensor devices, data aggregated from various different data repositories, etc.). In some implementations, one or more data sources can be hosted by the computing device 1010 (e.g., using the storage device(s) 1040). In some implementations, one or more data sources can be hosted by a different computing device. Data can be provided by the data source(s) 1090 in response to a request for data from the computing device 1010 and/or can be provided without such a request. For example, a pull technology can be used in which the provision of data is driven by device requests, and/or a push technology can be used in which the provision of data occurs as the data becomes available (e.g., real-time data streaming and/or notifications). Various sorts of data sources can be used to implement the techniques described herein, alone or in combination.

In some implementations, a data source can include one or more data store(s) 1090a. The database(s) can be provided by a single computing device or network (e.g., on a file system of a server device) or provided by multiple distributed computing devices or networks (e.g., hosted by a computer cluster, hosted in cloud storage, etc.). In some implementations, a database management system (DBMS) can be included to provide access to data contained in the database(s) (e.g., through the use of a query language and/or application programming interfaces (APIs)). The database(s), for example, can include relational databases, object databases, structured document databases, unstructured document databases, graph databases, and other appropriate types of databases.

In some implementations, a data source can include one or more blockchains 1090b. A blockchain can be a distributed ledger that includes blocks of records that are securely linked by cryptographic hashes. Each block of records includes a cryptographic hash of the previous block, and transaction data for transactions that occurred during a time period. The blockchain can be hosted by a peer-to-peer computer network that includes a group of nodes (e.g., computing devices) that collectively implement a consensus algorithm protocol to validate new transaction blocks and to add the validated transaction blocks to the blockchain. By storing data across the peer-to-peer computer network, for example, the blockchain can maintain data quality (e.g., through data replication) and can improve data trust (e.g., by reducing or eliminating central data control).

In some implementations, a data source can include one or more machine learning systems 1090c. The machine learning system(s) 1090c, for example, can be used to analyze data from various sources (e.g., data provided by the computing device 1010, data from the data store(s) 1090a, data from the blockchain(s) 1090b, and/or data from other data sources), to identify patterns in the data, and to draw inferences from the data patterns. In general, training data 1092 can be provided to one or more machine learning algorithms 1094, and the machine learning algorithm(s) can generate a machine learning model 1096. Execution of the machine learning algorithm(s) can be performed by the computing device 1010, or another appropriate device. Various machine learning approaches can be used to generate machine learning models, such as supervised learning (e.g., in which a model is generated from training data that includes both the inputs and the desired outputs), unsupervised learning (e.g., in which a model is generated from training data that includes only the inputs), reinforcement learning (e.g., in which the machine learning algorithm(s) interact with a dynamic environment and are provided with feedback during a training process), or another appropriate approach. A variety of different types of machine learning techniques can be employed, including but not limited to convolutional neural networks (CNNs), deep neural networks (DNNs), recurrent neural networks (RNNs), and other types of multi-layer neural networks.

Various implementations of the systems and techniques described herein can be realized in digital electronic circuitry, integrated circuitry, specially designed ASICs (application specific integrated circuits), computer hardware, firmware, software, and/or combinations thereof. A computer program product can be tangibly embodied in an information carrier (e.g., in a machine-readable storage device), for execution by a programmable processor. Various computer operations (e.g., methods described in this document) can be performed by a programmable processor executing a program of instructions to perform functions of the described implementations by operating on input data and generating output. The described features can be implemented in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, by a computer to perform a certain activity or bring about a certain result. A computer program can be written in any form of programming language, including compiled or interpreted languages, and can be deployed in any form, including as a stand-alone program or as a module, component, subroutine, or other unit suitable for use in a computing environment. A computer program product can be a computer- or machine-readable medium, such as a storage device or memory device. As used herein, the terms machine-readable medium and computer-readable medium refer to any computer program product, apparatus and/or device (e.g., magnetic discs, optical disks, memory, etc.) used to provide machine instructions and/or data to a programmable processor, including a machine-readable medium that receives machine instructions as a machine-readable signal. The term machine-readable signal refers to any signal used to provide machine instructions and/or data to a programmable processor.

Suitable processors for the execution of a program of instructions include, by way of example, both general and special purpose microprocessors, and can be a single processor or one of multiple processors of any kind of computer. Generally, a processor will receive instructions and data from a read-only memory or a random access memory or both. The elements of a computer are a processor for executing instructions and one or more memory devices for storing instructions and data. Generally, a computer can also include, or can be operatively coupled to communicate with, one or more mass storage devices for storing data files. Such devices can include magnetic disks (e.g., internal hard disks and/or removable disks), magneto-optical disks, and optical disks. Storage devices suitable for tangibly embodying computer program instructions and data can include all forms of non-volatile memory, including by way of example semiconductor memory devices, flash memory devices, magnetic disks (e.g., internal hard disks and removable disks), magneto-optical disks, and optical disks. The processor and the memory can be supplemented by, or incorporated in, ASICs (application-specific integrated circuits).

The systems and techniques described herein can be implemented in a computing system that includes a back end component (e.g., a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). The computer system can include clients and servers, which can be generally remote from each other and typically interact through a network, such as the described one. The relationship of client and server arises by virtue of computer programs running on the respective computers and having a client-server relationship to each other.

While this specification contains many specific implementation details, these should not be construed as limitations on the scope of the disclosed technology or of what may be claimed, but rather as descriptions of features that may be specific to particular embodiments of particular disclosed technologies. Certain features that are described in this specification in the context of separate embodiments can also be implemented in combination in a single embodiment in part or in whole. Conversely, various features that are described in the context of a single embodiment can also be implemented in multiple embodiments separately or in any suitable subcombination. Moreover, although features may be described herein as acting in certain combinations and/or initially claimed as such, one or more features from a claimed combination can in some cases be excised from the combination, and the claimed combination may be directed to a subcombination or variation of a subcombination. Similarly, while operations may be described in a particular order, this should not be understood as requiring that such operations be performed in the particular order or in sequential order, or that all operations be performed, to achieve desirable results. For example, in at least some embodiments, one or more of the actions disclosed in the flowchart of FIGS. 2A-2B can be modified, skipped over, removed, and/or replaced without departing from the spirit of the present disclosure. The inclusion of all the disclosed actions does not require that all such actions must be performed, and thus it is contemplated that claims directed to any subset of the actions disclosed can be performed in a claimed method or by a claimed system. Particular embodiments of the subject matter have been described. Other embodiments are within the scope of the following claims.

1. A system for training a user model to be robust against convolutional perturbations, the system comprising:
a computing system comprising processors and memory configured to store instructions that, when executed by the processors, causes the processors to perform a process comprising:
receiving user input comprising a user model;
constructing perturbation kernels based on the user input;
deriving parameterized versions of the perturbation kernels as one or more matrices;
precomputing results of convolving input data for the user model with the one or more matrices;
prepending a threshold number of layers to the user model based on the precomputed results to generate an augmented model;
determining bounds for the augmented model;
updating parameters for the augmented model based on the determined bounds; and
returning output based on the augmented model.

2. The system of claim 1, wherein the process comprises:
selecting a batch of input training data; and
constructing the perturbation kernels based on the batch of input training data.

3. The system of claim 1, wherein prepending the threshold number of layers to the user model comprises encoding convolutional perturbations for the convolving input data to generate the augmented model.

4. The system of claim 1, wherein determining the bounds for the augmented model comprises determining bounds for intermediate nodes in the augmented model.

5. The system of claim 1, wherein determining the bounds for the augmented model comprises determining upper and lower bounds on a loss function for the augmented model.

6. The system of claim 1, wherein updating the parameters is further based on a robust loss.

7. The system of claim 1, wherein the process further comprises:
removing the prepended layers to obtain the user model;
determining whether one or more processing conditions are satisfied; and
based on a determination that the one or more processing conditions are satisfied, returning output indicating that the user model is optimized and robustified against perturbations.

8. The system of claim 1, wherein the user model comprises a neural network.

9-13. (canceled)

14. A method for training a user model to be robust against convolutional perturbations, the method comprising:
receiving user input comprising a user model;
constructing perturbation kernels based on the user input;
deriving parameterized versions of the perturbation kernels as one or more matrices;
precomputing results of convolving input data for the user model with the one or more matrices;
prepending a threshold number of layers to the user model based on the precomputed results to generate an augmented model;
determining bounds for the augmented model;
updating parameters for the augmented model based on the determined bounds; and
returning output based on the augmented model.

15. The method of claim 14, wherein the method further comprises:
electing a batch of input training data; and
constructing the perturbation kernels based on the batch of input training data.

16. The method of claim 14, wherein prepending the threshold number of layers to the user model comprises encoding convolutional perturbations for the convolving input data to generate the augmented model.

17. The method of claim 14, wherein determining the bounds for the augmented model comprises determining bounds for intermediate nodes in the augmented model.

18. The method of claim 14, wherein determining the bounds for the augmented model comprises determining upper and lower bounds on a loss function for the augmented model.

19. The method of claim 14, wherein updating the parameters is further based on a robust loss.

20. The method of claim 14, wherein the method further comprises:
removing the prepended layers to obtain the user model;
determining whether one or more processing conditions are satisfied; and
based on a determination that the one or more processing conditions are satisfied, returning output indicating that the user model is optimized and robustified against perturbations.

21. The method of claim 14, wherein the user model comprises a neural network and the user input further comprises the input data for the model.

22. (canceled)

23. The method of claim 14, wherein the one or more matrices comprise coefficient matrices and a bias matrix.

24. The method of claim 14, wherein the perturbation kernels comprise at least one of box blur kernels, sharpen kernels, or motion blur kernels.

25. A method for training a user model to be robust against convolutional perturbations, the method comprising:
receiving user input comprising a user model;
constructing perturbation kernels based on the user input;
providing the user input and the perturbation kernels to a training pipeline;
receiving, as output from the training pipeline, results indicating robustness of the user model; and
returning the output.

26. The method of claim 26, wherein the training pipeline comprises:
deriving parameterized versions of the perturbation kernels as one or more matrices;
precomputing results of convolving input data for the user model with the one or more matrices;
prepending a threshold number of layers to the user model based on the precomputed results to generate an augmented model;
determining bounds for the augmented model; and
updating parameters for the augmented model based on the determined bounds.

27. (canceled)
